(19) United States
(12) Patent Application Publication
(10) Pub. No.: US 2010/0268411 A1
(43) Pub. Date: Oct. 21, 2010

(54) Charge monitor apparatus, electric vehicle, and server

(75) Inventor: Shinya Taguchi, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/662,375

(22) Filed: Apr. 13, 2010

(30) Foreign Application Priority Data
Apr. 13, 2009 (JP) 2009-97068

(51) Int. Cl. G06F 7/00; H02J 7/00

(52) U.S. Cl. 701/33

(57) ABSTRACT

In an electric vehicle equipped with a charge system, a communications condition, which is used to execute data communications to transmit to an outside, is previously designated based on an instruction by a user. When the designated communications condition becomes satisfied, the data communications from the vehicle is started to transmit a charge state to a server which is a communications partner designated previously. Therefore, a user can detect the charge state of the electric vehicle without need of accessing the electric vehicle, even if not reaching a full charge state.

### CROSS REFERENCE TO RELATED APPLICATION

The present application is based on and incorporates herein by reference Japanese Patent Application No. 2009-97068 filed on Apr. 13, 2009.

### FIELD OF THE INVENTION

The present invention relates to a charge monitor apparatus, an electric vehicle, and a server.

### BACKGROUND OF THE INVENTION

[Patent document 1] JP-2004-048090 A

Patent document 1 describes an in-vehicle charge monitor apparatus to monitor a charge state of an electric vehicle with a function of a wireless telephone. The charge monitor apparatus transmits a charge state of the vehicle to an outside of the vehicle using the wireless telephone when reaching the full charge state or when receiving an access of a user.

There may be a case that a user does not necessarily want the charge to be continued up to the full charge state. This is because the user only wants to reach a destination and does not want to wait a prolonged time for the full charge. In such a case, for instance, if the user intends to charge only up to a predetermined charge amount less than the full charge amount, the user needs to frequently access the charge monitor apparatus in order to confirm the charge state (i.e., the charge amount), thereby posing troublesomeness.

### SUMMARY OF THE INVENTION

It is an object of the present invention to provide the following technology for a vehicle such as an electric vehicle, which is charged by an outside electric power source and runs with the charged electric power. A charge state of the vehicle can be monitored by a charge monitor apparatus, and the monitored charge state can be detected at a desired timing without need of directly accessing the monitor apparatus.

To achieve the above object, according to an example of the present invention, a charge monitor apparatus is provided as follows. The apparatus monitors a charge state in an electric vehicle, which receives a charge by an electric power supplied from an outside electric power source, the electric vehicle traveling using an electric power due to the charge. A charge state acquisition section is configured to acquire a charge state of the electric vehicle. A communications condition designation section is configured to designate a communications condition, which is used to transmit the acquired charge state, based on an instruction by a user. A communications section is configured to execute data communications to transmit the charge state to a predetermined communications partner when the designated communications condition is satisfied.

Under such a configuration of the charge monitor apparatus, the charge state is transmitted to a predetermined communications partner when the communications condition, which a user designated or predetermined, is satisfied. Therefore, the user can detect the charge state of the vehicle without need of accessing the electric vehicle, even if not reaching a full charge state.

It is noted that the “communications partner” may be a terminal apparatus which is held, carried, or possessed by a user who designated the communications condition, or an apparatus having a function which notifies the user of the charge state, such as a server, a display device to display the charge state, and an apparatus which relays information on charge state to a user's terminal apparatus. In addition, the “charge state” may represent a parameter about the charge of an electric vehicle such as an error during charging, a voltage value or electric current value of the battery, or a charge period.

In addition, the “communications condition” may be a predetermined period, a clock time, or a vehicular environment such as a charge state or vehicle state. A parameter of a comparison target used when determining whether to reach the designated communications condition is varied depending on which “communications condition” is designated. For instance, when an elapsed time or a clock time is designated as the communications condition, a comparison target for determining may be a detection result by a timer or a clock. In contrast, when a vehicular environment such as a charge state or vehicle state is designated, a comparison target may be a detection result by a corresponding sensor.

According to another example of the present invention, a charge monitor apparatus is provided as follows. The apparatus monitors a charge state in an electric vehicle, which receives a charge by an electric power supplied from an outside electric power source, the electric vehicle traveling using an electric power due to the charge. A charge state acquisition section is configured to acquire a charge state of the electric vehicle. A communications section is configured to execute data communications to transmit the charge state to a communications partner designated previously when the acquired charge state indicates a charge amount that is previously designated as being less than a full charge amount.

Thus, the user can detect the charge state of the vehicle without need of accessing the electric vehicle, even if not reaching a full charge state.

According to another example of the present invention, an electric vehicle is provided as follows. The electric vehicle indicates a vehicle, which receives a charge by an electric power supplied from an outside electric power source and travels using an electric power due to the charge. The electric vehicle further comprise a function of one of the above mentioned charge monitor apparatuses.

According to another example of the present invention, a server is provided as follows. A reception section is configured to receive information on charge state from an electric vehicle that indicates a vehicle, which receives a charge by an electric power supplied from an outside electric power source and travels using an electric power due to the charge. A transmission section is configured to transmit the received information on charge state to a predetermined communications partner. The server further comprises a function of one of the above mentioned charge monitor apparatuses.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating an overall configuration of a charge system according to an embodiment of the present invention;

FIG. 2 is a flowchart illustrating a vehicle-side process;

FIG. 3 is a flowchart illustrating a charge amount designation process;

FIG. 4 are diagrams illustrating examples of display windows in an in-vehicle display device when a user designates a charge amount;

FIG. 5A is a diagram illustrating a travel-possible range;

FIG. 5B is a diagram illustrating data elements transmitted from a vehicle to a server;

FIG. 6 is a flowchart illustrating a transmission condition designation process;

FIG. 7 is a flowchart illustrating a charge mid-course process;

FIG. 8A is a flowchart illustrating a charge information reception process; and

FIG. 8B is a flowchart illustrating an information request signal reception process.

### DETAILED DESCRIPTION OF THE PREFERRED EMBODIMENTS

Hereafter, description will be given to an embodiment of the present invention with reference to the drawings.

[Configuration]

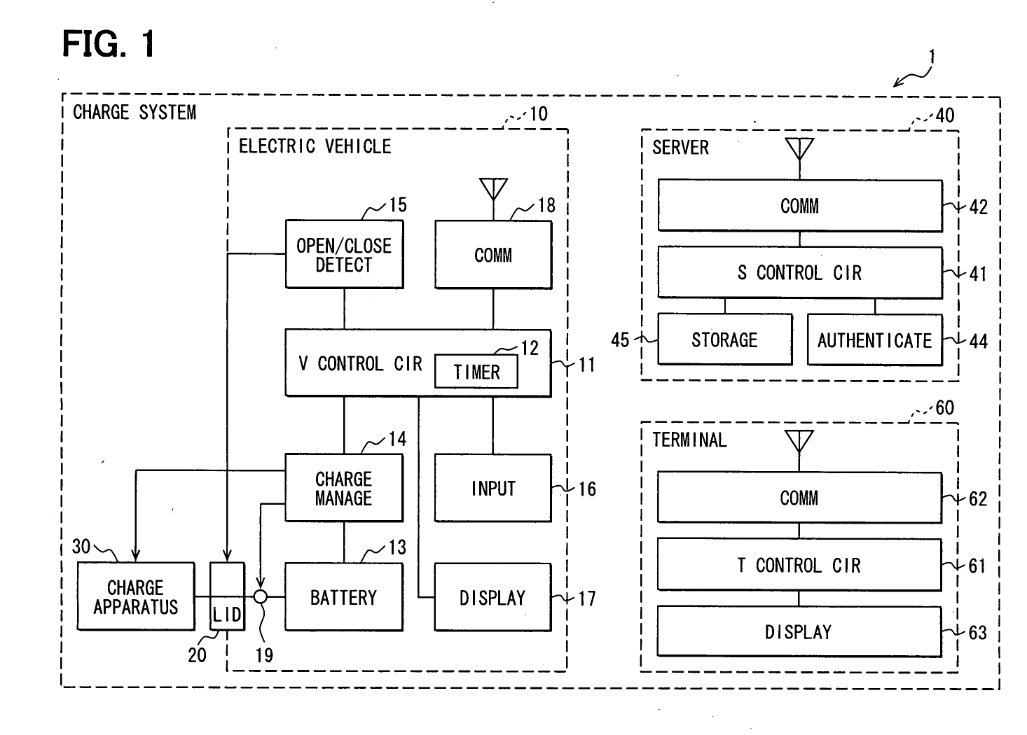

FIG. 1 is a block diagram showing an overall configuration of a charge system 1 according to an embodiment of the present invention. The charge system 1 includes an electric vehicle 10 also serving as a charge monitor apparatus, a server 40 also serving as a relaying apparatus, and a terminal apparatus 60. The electric vehicle 10 and the terminal apparatus 60 can execute data communications with each other via the server 40 intermediating therebetween.

The electric vehicle 10 is connected with a charge apparatus 30 which is an outside electric power source. The electric power is supplied from the charge apparatus 30 so as to charge a battery 13 of the electric vehicle 10. The charged electric power is used for the vehicle to travel or run. In the present embodiment, the electric vehicle 10 may be defined as any vehicle to use an electric power charged by an outside electric power source, regardless of additionally using another energy source. Thus, a plug-in hybrid vehicle may be included in the electric vehicle 10.

In addition, the electric vehicle 10 also servers as a charge monitor apparatus to have a function to monitor or check a state of a charge (i.e., a charge state) with respect to a voltage value, an electric current value, and an error at charging when the charge apparatus 30 executes a charge to the battery 13. The electric vehicle 10 includes a charge control circuit 11 (also referred to as a vehicle control circuit), a charge management device 14, an open-close detection device 15, a vehicle input device 16, a vehicle display device 17, and a vehicle communications device 18.

The charge management device 14 responds to an instruction from the vehicle control device 11 to thereby transmit an instruction to instruct the charge apparatus 30 to start or stop the supply of electric power. In addition, the charge management device 14 also executes an open-close operation of a contact point for a switch 19, which is arranged in an electric route which connects the battery 13 with the charge apparatus 30.

In other words, the charge management device 14 can respond to the following first and second types of the charge apparatus 30. The first type of the charge apparatus 30 is to only supply an electric power like a home electric socket; the second type has a function to control an electric power amount during charge depending on the state of the battery 13 and change the electric power amount according to an instruction from the electric vehicle 10. In addition, the charge management device 14 detects the charge state during the charge, and sends information on charge state to the vehicle control circuit 11. Furthermore, the above-mentioned switch 19 is in an OFF state when the vehicle-side process mentioned later is started.

The open-close detection device 15 is a storage lid for a space storing or accommodating a connector which is connected with a charge-use cable, which leads to the charge apparatus 30, when the electric vehicle 10 is charged. The open-close detection device 15 detects an open-close state of the storage lid, which corresponds to a filler cap in a gasoline-powered vehicle. In the present embodiment, the storage lid is turned into an open state at charging and into a close state at traveling.

The vehicle input device 16 functions as an interface for a user of the electric vehicle 10 to input an instruction to the vehicle control circuit 11. In addition, the vehicle display device 17 is to display a process execution result by the vehicle control circuit 11.

In particular, in the present embodiment, the vehicle display device 17 is used in common as a display device of a well-known navigation apparatus. The vehicle input device 16 is configured as a touch panel in the display device of the navigation apparatus.

The vehicle communications device 18 (also referred to as a communications section of the vehicle) is a well-known wireless communications module to achieve data communications between the electric vehicle 10 and an outer apparatus. The vehicle communications device 18 transmits predetermined information to the server 40 according to an instruction of the vehicle control circuit 11, or receives predetermined information from the server 40.

The vehicle control circuit 11, i.e., the charge control circuit, is a known microcomputer containing a CPU, ROM, and RAM. The vehicle control circuit 11 transmits the charge state detected by the charge management device 14 to the server 40, and manages the charge state based on the designation by the user. In addition, the charge control circuit 11 also has a function as a timer 12. The timer 12 has a function to measure an elapsed time since the vehicle control circuit 11 transmits the information on charge state via the vehicle communications device 18.

Next, the server 40 includes a server control circuit 41, a server communications device 42, a storage device 43, and an authentication device 44. The server communications device 42 (also referred to as a communications section of the server) is a well-known wireless communications module to realize data communications between the server 40 and an outside apparatus. In particular, the server communications device 42 transmits and receives data with several electric vehicles 10 or several terminal apparatuses 60. Thus, the server communications device 42 may function as a reception section and a transmission section.

The storage device 43 is a well-known memory device, and used as a database to store information on charge state of the several electric vehicles 10. The authentication device 44 has a function to authenticate a user when receiving an access from the terminal apparatus 60 of the user.

The server control circuit 41 is a known microcomputer containing a CPU, ROM, and RAM. The server control circuit 41 receives the charge information from the electric vehicle 10 and stores the received charge information for every vehicle, or transmits the charge information to the terminal apparatus 60 the user holds, carries, or possesses.

Next, the terminal apparatus 60 is configured to be a cellular phone or PDA (i.e., Personal Digital Assistant) held by each user of the electric vehicle 10. The terminal apparatus 60 includes a terminal control circuit 61, a terminal communications device 62, and a terminal display device 63. The terminal communications device 62 is a well-known wireless communications module to realize data communications between the terminal apparatus 60 and an outside apparatus. In particular, the terminal communications device 62 transmits and receives data with the server 40.

The terminal display device 63 is to display information or a message to indicate an error or completion of charging. The terminal control circuit 61 is a known microcomputer containing a CPU, ROM, and RAM. The terminal control circuit 61 generates an image corresponding to data which is received from the server 40 and displays the generated image in the terminal display device 63. In addition, the terminal control circuit 61 executes a process according to an instruction, which is issued by the user of the terminal apparatus 60 via a terminal manipulation device (unshown). For example, the terminal control circuit 61 executes a process to transmit a charge information request signal to request from the server 40 a charge state of the electric vehicle 10 which the user of the terminal apparatus 60 uses or possesses, and obtain the charge information. It is noted that the charge information request signal contains vehicle identification information (i.e., a password) for identifying the user of the electric vehicle 10. Upon receiving the charge information request signal, the server 40 executes an authentication process to verify an accessing person using the vehicle identification information, and transmits the charge information to the terminal apparatus 60 only when the authentication is correctly or successfully completed.

[Process]

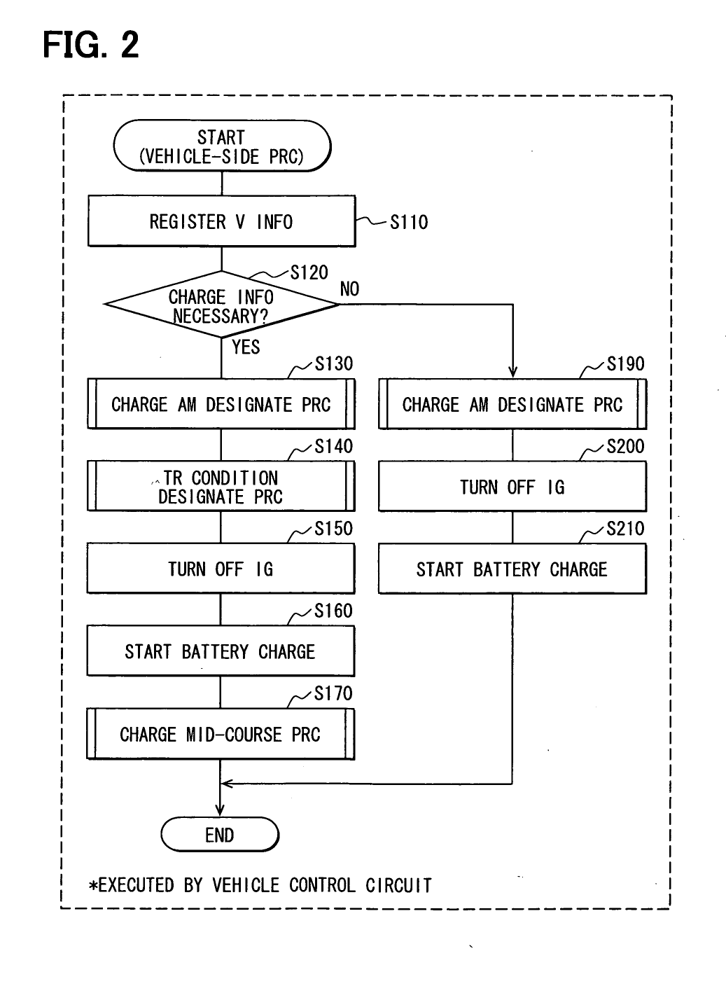

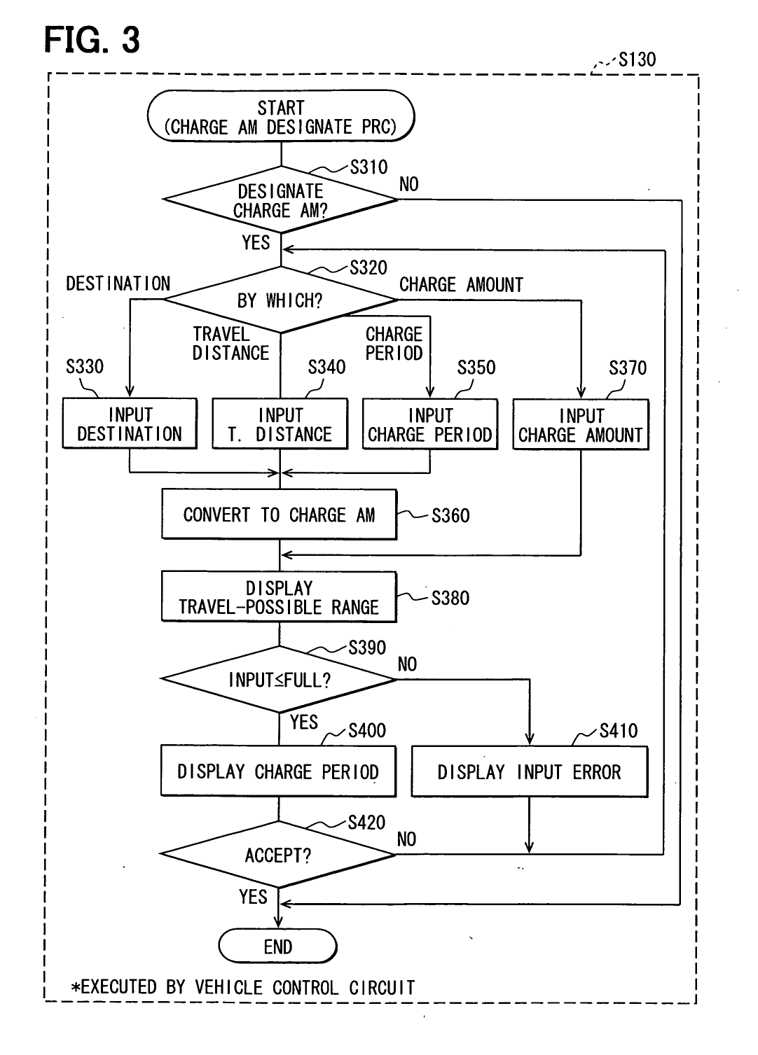

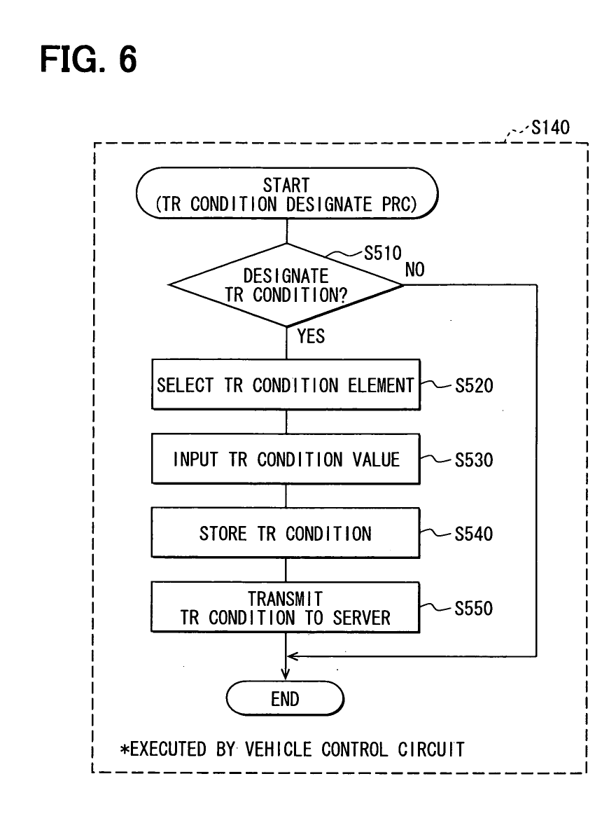

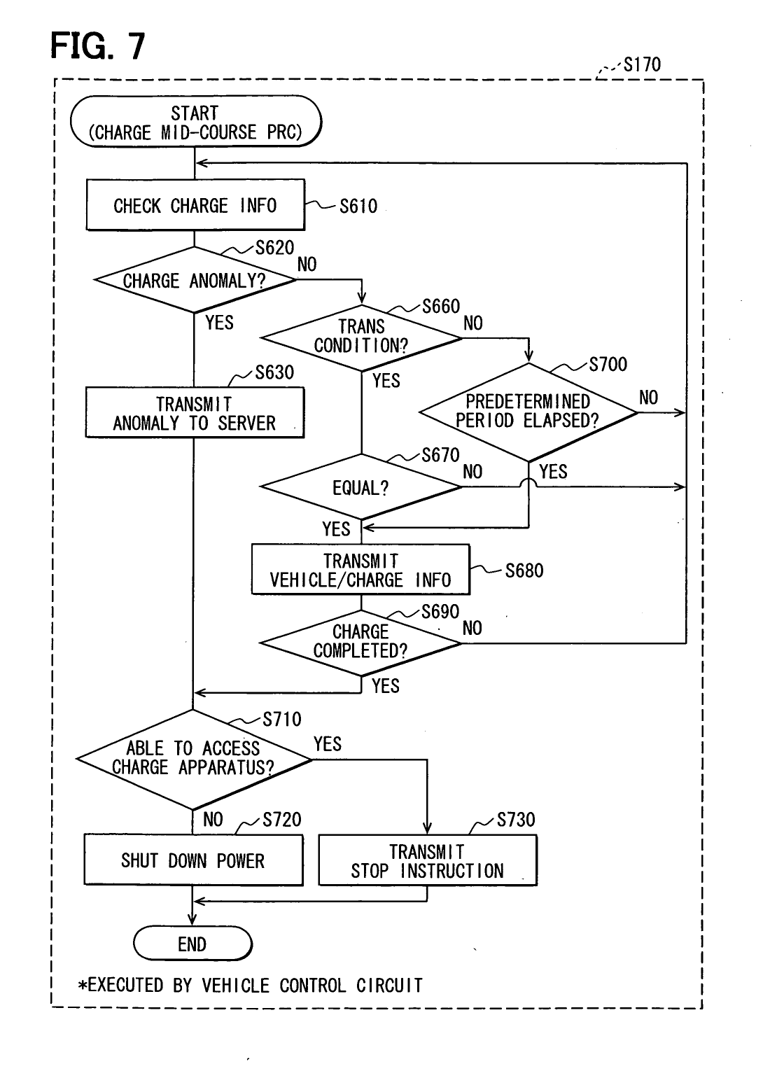

In the charge system 1, while monitoring a charge state of the electric vehicle 10, the electric vehicle 10 executes a process to transmit to the server the charge state when a predetermined transmission condition is satisfied or reached. FIG. 2 is a flowchart illustrating a vehicle-side process executed by the vehicle control circuit 11 of the electric vehicle 10. FIG. 3 is a flowchart illustrating a charge amount designation process included in the vehicle-side process. FIG. 6 is a flowchart illustrating a transmission condition designation process included in the vehicle-side process. FIG. 7 is a flowchart illustrating a charge mid-course process included in the vehicle-side process.

It is noted that a flowchart or the processing of the flowchart in the present application includes sections (also referred to as steps), which are represented, for instance, as S110. Further, each section can be divided into several sub-sections while several sections can be combined into a single section. Furthermore, each of thus configured sections can be referred to as a means or unit and achieved not only as a software device but also as a hardware device.

The vehicle-side process is started when a start of the charge of the electric vehicle 10 is detected, for example, when the open-close detection device 15 detects that the storage lid 20 connected with the charge cable is turned into a close state. In the vehicle-side process, as shown in FIG. 2, vehicle information is registered (S110). It is noted that the vehicle information signifies varieties of information such as the number of the vehicle (the character and numeral of the license plate), a type of the vehicle, a unique ID for identifying the vehicle, and a mail address of contact information (communications destination).

Then, it is determined whether the charge information needs to be transmitted to the terminal apparatus 60 (S120). Herein, such a determination may be made by using a selection result previously inputted by the user. Alternatively, an image for the user to make the determination may be displayed in the vehicle display device 17; thereby, the determination may be made by using an input result via the vehicle input device 16 by the user responding to the displayed image.

When it is necessary to transmit the charge information to the terminal apparatus 60 (S120: YES), a charge amount designation process to be mentioned later (S130), and a transmission condition designation process (S140: also referred to as a communications condition designation means or section) are executed. Then, the power source of the vehicle such as an ignition switch is turned into the OFF state (S150). Then, the charge to the battery 13 is started (S160: also referred to as a charge start instruction transmission means or section).

Herein, while transmitting a charge start instruction signal to the charge apparatus 30, the switch 19 is turned into the ON state to thereby electrically connect the battery 13 with the charge apparatus 30. The charge to the battery 13 from the charge apparatus 30 is thus started.

After S160 is completed, the charge mid-course process to be mentioned later is executed (S170). After the charge mid-course process is completed, the vehicle-side process is ended. In contrast, when it is not necessary to transmit the charge information to the terminal apparatus 60 (S120: NO), The charge amount designation process is executed like S130 (S190). Then, when the charge amount designation process is completed, the power source of the vehicle such as the ignition switch is turned into the OFF state (S200). Then, the charge to the battery 13 is started (S210: also referred to as a charge start instruction transmission means or section). The present vehicle-side process is then ended.

Next, the charge amount designation process (S130) is explained. It is noted that in the charge amount designation process, S320 to S370 may function as a charge amount designation means or section or a charge amount re-designation means or section.

In the charge amount designation process, as illustrated in FIG. 3, it is determined whether an amount of charge (i.e., charge amount) is set up or designated (S510). Herein, like S120, such a determination may be made by using a selection result previously inputted by the user. Alternatively, an image for the user to make the determination may be displayed in the vehicle display device 17; thereby, the determination may be made by using an input result via the vehicle input device 16 by the user responding to the displayed image.

It is noted that the “charge amount” may signify any one of (i) an electric amount posterior to charge, (ii) a proportion of an electric amount posterior to charge to a full charge amount (i.e., a charge amount at the full charge state), and (iii) an electric power amount supplied at the present charge. In the present embodiment, unless otherwise explicitly indicated, the “charge amount” is defined as a proportion (%) of an electric power amount posterior to charge to an electric power amount at the full charge state (also referred to as a full-charged electric power amount).

When the charge amount is not designated (S310: NO), the charge amount designation process is ended promptly. In contrast, when the charge amount is designated (S310: YES), a process is executed so as to correspond to a result of user's selection of item used for designating the charge amount (S320).

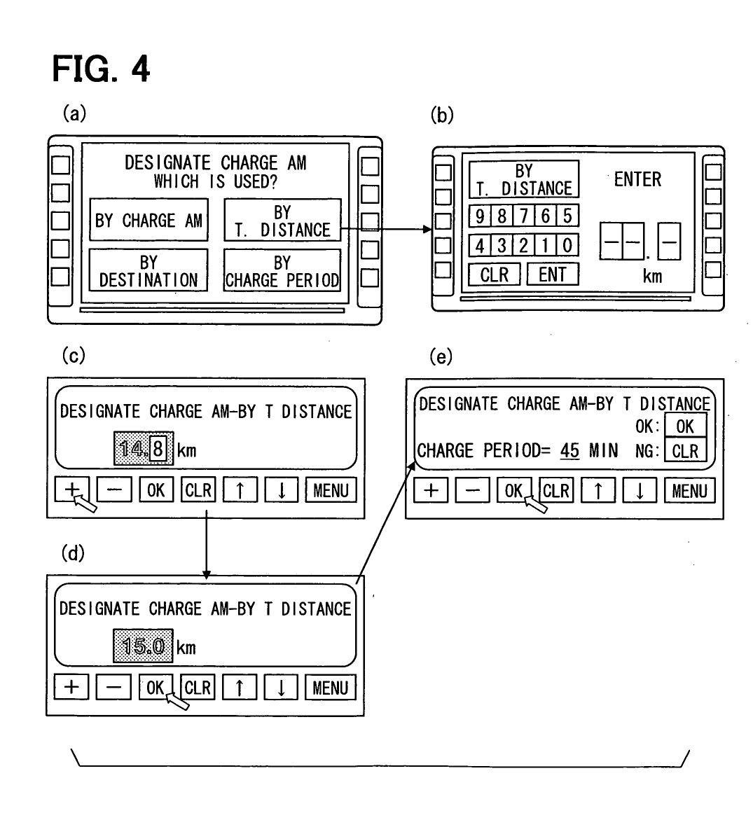

As illustrated in (a) of FIG. 4, an image is generated so as to enable the user to select one of items used for designating the charge amount, and displayed in the vehicle display device 17. It is then determined whether an input is made which selects one of the several selection items via the vehicle input device 16. When an input is determined to be made, a process is made so as to correspond to the result of the determined input.

For instance, when a destination is selected (S320: DESTINATION), a process known in a navigation apparatus is executed so as to input a destination (S330). Then the processing advances to S360 to be mentioned later.

For instance, when a travel distance is selected (S320: T DISTANCE), a processing is executed so as to input (a value of) a travel distance (S340). For instance, as shown in (b) of FIG. 4, an image is generated so as to enable the user to input (a value of) a travel distance, and displayed in the vehicle display device 17.

A numeral value inputted to the displayed image via the vehicle input device 16 is inputted as a travel distance. The processing then advances to S360 to be mentioned later. In contrast, for instance, when a charge time or period is selected (S320: CHARGE PERIOD), a process is executed so as to input (a value of) a charge period (S350). In the process, an image is generated so as to enable the user to input (a value of) a charge period similarly to the mentioned above and displayed in the vehicle display device 17. A numeral value inputted to the displayed image via the vehicle input device 16 is inputted as a charge period.

The processing then advances to S360 similarly. At S360, a process is executed so as to convert the inputted information into a charge amount (S360: also referred to as a conversion means or section). For instance, when a “destination” is inputted, a distance to the inputted destination is obtained using a function of the navigation apparatus to thereby calculate a charge amount (electric power amount posterior to charge) using the following computing equation.

“Charge amount”={(“Distance to destination”/“Travel-possible distance per unit electric power amount”)+“electric power due to electric loss”}×Safety factor

The following indicates a procedure to obtain a charge amount, for example.

[1] Receiving “destination” as a selection item by the user;

[2] Calculating a distance to the destination using the navigation apparatus (for example, 15 km);

[3] Calculating a minimum necessary charge amount by dividing the distance to the destination by a travel-possible distance (e.g., 2 km) which the subject vehicle 10 can travel using 1% of the electric power amount at the full charge state (15/2=7.5%);

[4] Adding an electric power due to charge loss (e.g., 5%) (7+5=12.5%); and

[5] Multiplying by the safety factor (e.g., 1.2) to thereby obtain the charge amount (12.5×1.2=15%).

It is noted that a value of “electric power due to power loss” is determined in consideration of road configuration information such as an uphill, congestion information such as a time to arrival, a time zone (whether to need lighting or not), a weather (whether to need an movement of a wiper), a body weight, a use state of an air-conditioner, etc. When determining the value, a necessary travel time to reach a destination in consideration of a traffic congestion may be multiplied by the electric power due to the power loss per unit time. In addition, the “safety factor” is a value as an emergency power to prevent the battery from running down immediately after arriving at the destination.

In addition, when the “travel distance” is inputted, the charge amount is calculated using the following computing equation.

“Charge amount”=(“Inputted travel distance”/“Travel-possible distance per unit electric power amount”)×Safety factor

The following indicates a procedure to obtain a charge amount, for example.

[1] Receiving an input of the travel distance by the user (e.g., 20 km);

[2] Calculating a minimum necessary charge amount by dividing the distance to the destination by a travel-possible distance (e.g., 1 km) which the subject vehicle 10 can travel using 1% of the electric power amount at the full charge state (20/1=20%);

[3] Retrieving a route having the greatest power loss from a present position and adding an electric power due to charge loss (for example, 10%) (20+10=30%); and

[4] Multiplying by the safety factor (e.g., 1.2) to thereby obtain the charge amount (30×1.2=36%).

Furthermore, when the “charge period” is inputted, a charge amount is calculated based on a known characteristic at charging the battery 13, or a temperature condition such as an atmospheric temperature. Further, when a direct input of a charge amount is selected at S320, a process is executed so as to input a charge amount (S370). In the process, an image is generated so as to enable the user to input a charge amount similarly to the mentioned above and displayed in the vehicle display device 17. A numeral value inputted to the displayed image via the vehicle input device 16 is inputted as a charge amount. In the above sequence, the processing advances to S380, without need of converting the inputted data into the charge amount.

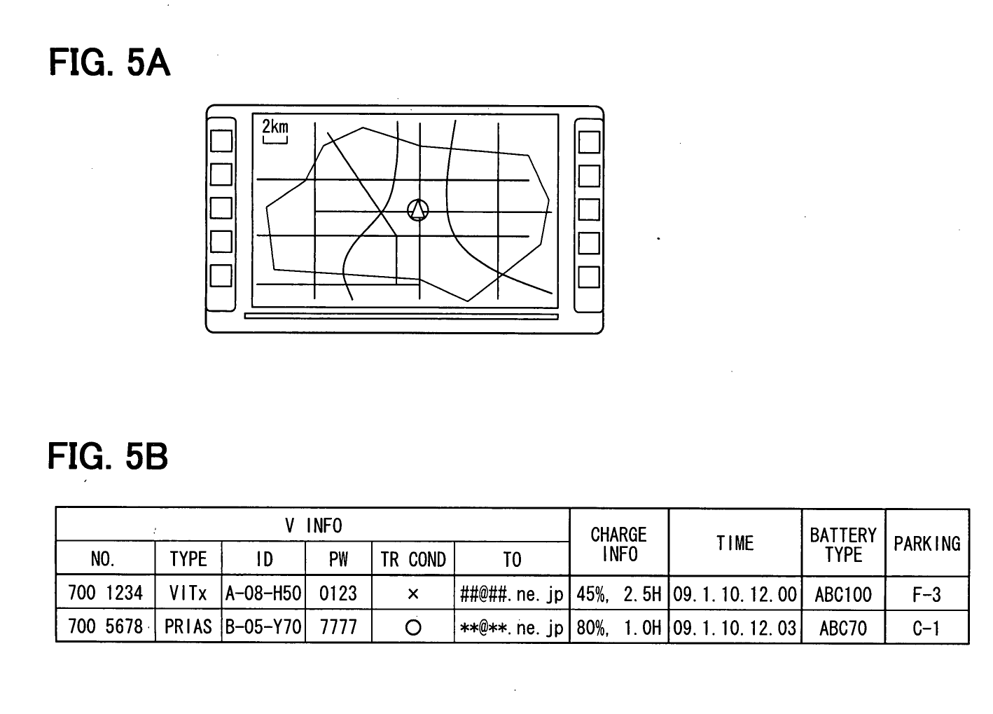

At S380, a travel-possible range by the designated charge amount is displayed as an image in the vehicle display device 17 (S380: a display management means or section). For instance, a travel-possible distance is obtained by multiplying an electric power amount posterior to charge by a travel-possible distance per unit electric power amount. The obtained travel-possible distance is used as a radius to draw a circle centering on the present position in a map displayed. In the present embodiment, as illustrated in FIG. 5A, an image is generated so as to illustrate a travel-possible range relative to each road in consideration of a power consumption of a headlight, etc., and an arrival delay time based on congestion information. Therefore, the vehicle display device 17 displays an image of a display window to illustrate travel-possible distances that are different from each other depending on the respective traveled roads.

Then, it is determined whether a value of the inputted charge amount is equal to or less than the full charge amount (i.e., electric power amount at the full charge state) (S390). Herein, the value of the full charge amount is stored previously in the ROM of the vehicle control circuit 11; the above determination is made by comparing the stored value of the full charge amount with the inputted value.

When the value of the inputted charge amount is equal to or less than the full charge amount (S390: YES), a charge period is calculated which is necessary to charge up to the inputted charge amount and displayed in the vehicle display device 17 (S400: a charge period calculation means or section). For instance, a map is prepared which associates a charge period with a charge increase amount that is increased by the charge (charge increase: difference between the charge amount posterior to charge and the present charge amount). That is, the present charge amount is detected based on the present voltage value or the like of the battery 13. When the charge amount posterior to charge is designated, the charge increase amount is calculated. Then, the charge period corresponding to the calculated charge increase amount may be read from the map.

In addition, the charge to the battery 13 is executed temporarily; thereby, the charge period may be predicted based on the electric power amount increased in the battery 13 per unit time, which is obtained by the above temporary charge. Then, it is confirmed or requested whether the user agrees with a start of the charge based on the charge amount (charge period), thereby determining a reply result of the input by the user (S420: a reply request means or section). Herein, like the above, an image may be generated so as to request the user to reply whether to accept or not and displayed in the vehicle display device 17. Thus, the above determination can be made according to the reply result or input result via the vehicle input device 16.

When the reply indicating the acceptance of the charge amount is received from the user (S420: YES), the charge amount designation process is ended. In contrast, when the reply indicating the refusal of the charge amount is received from the user (S420: NO), the processing at S320 and subsequent is repeated. That is, re-designation of the charge amount is requested again to the user.

In addition, when the inputted value of the charge amount is greater than the full charge amount (S390: NO), an error message which indicates that the inputted value is an error is displayed in the vehicle display device 17 (S410), and the processing returns to S320. Also in this case, the re-designation of the charge amount is requested to the user again.

Next, a transmission condition designation process is explained with reference to FIG. 6. The transmission condition designation process is to designate a communications condition at the time of transmitting an obtained charge state to the server 40 based on an instruction by a user.

In the transmission condition designation process, as illustrated in FIG. 6, it is determined whether a communications condition is set up or designated (S510). Such a determination may be made by using a selection result previously inputted by the user. Alternatively, an image for the user to make the determination may be displayed in the vehicle display device 17; thereby, the above determination may be made using the user's determination result.

When it is determined that any transmission condition is not designated (S510: NO), the transmission condition designation process is ended promptly. When it is determined that a transmission condition is designated (S510: YES), an element of the transmission condition (also referred to as a transmission condition element) is selected (S520). It is noted that the transmission condition element signifies a type of the transmission condition such as every predetermined charge amount, every predetermined charge period, or only a specific charge amount. It is designed that a user can select any one among the several types of the transmission condition via the vehicle input device 16.

Then, the numerical value of the transmission condition is inputted (S530). Herein, the numerical value inputted via the vehicle input device 16 is adopted. The transmission condition containing the type inputted at S520 and the numeral value inputted at S530 are stored in the RAM of the vehicle control circuit 11 (S540).

Furthermore, several transmission condition elements may be provided for the designation at S520 and S530. For example, an intermediate condition and a final condition may be designated at the same time. The intermediate condition is, such as “every charge amount 10%,” used for transmitting information on charge state but terminating the charge. The terminating condition is such as “charge amount 65%,” used for terminating the charge and transmitting information on charge state.

Then, the designated transmission condition is transmitted to the server 40 (S550). The transmission condition designation process is then ended. Next, the charge mid-course process is explained using FIG. 7. It is noted that in the charge, mid-course process, S710 to S730 by the vehicle control circuit 11 may function as an anomaly shutoff means or section or a completion shutoff means or section. The charge mid-course process is continuously executed until the charge is completed. First, charge information is acquired from the charge management device 14, and the contents of the acquired charge information is confirmed (S610: also referred to as a charge state acquisition means or section).

Then, it is detected or determined whether an anomaly arises at the time of the charge to the electric vehicle 10 (S620: also referred to as an anomaly detection means or section). For instance, it is determined whether the charge information contains information on charge anomaly. The charge anomaly may include an anomaly of the battery 13 in respect of heat or fire detected by a temperature sensor (unshown), an anomaly of the battery 13 in respect of a voltage value being too high or too low, and an anomaly that an electric power supply is shut off during the charge. When such an anomaly is detected by the charge management device 14, the information on charge anomaly is written to the charge information.

When the information on charge anomaly is contained in the charge information (S620: YES), information indicating that the anomaly arises is transmitted to the server 40 (S630: also referred to as an anomaly detection means or section). Then the processing advances to S710 to be mentioned later. When the information on charge anomaly is not contained in the charge information (S620: NO), it is determined whether the transmission condition is designated in the above-mentioned transmission condition designation process (S660).

When the transmission condition is designated (S660: YES), it is determined whether the charge information accords with the transmission condition (S670: also referred to as a communications means or section). When the charge information does not accord with the transmission condition (S670: NO), the processing at S610 and subsequent is repeated. When the charge information accords with the transmission condition (S670: YES), the vehicle information and charge information are transmitted to the server 40 (S680: also referred to as a communications means or section). Then it is determined whether the charge is completed or not (S690).

In cases that the transmission condition is designated, it can be determined that the charge is completed when the charge information accords with the transmission condition. When the charge is completed (S690: YES), the processing advances to S710. When the charge is not completed (S690: NO), the processing at S610 and subsequent is repeated.

In contrast, when the transmission condition is not designated (S660: NO), it is determined whether a predetermined period, e.g., 10 minutes, elapses since the data is previously transmitted to the server 40 (S700). When the predetermined period elapses (S700: YES), the processing at S680 and subsequent is executed. When the predetermined period does not elapse (S700: NO), the processing at S610 and subsequent is repeated.

Next, at S710, it is determined whether the charge management device 14 can communicate with the charge apparatus 30 (S710). That is, in this processing, it is determined whether the charge apparatus 30 is capable of spontaneously operating.

When the charge management device 14 cannot communicate with the charge apparatus 30 (S710: NO), the switch 19 is mechanically turned into the (OFF state (S720). Thus, the charge mid-course process is ended. When the charge management device 14 can communicate with the charge apparatus 30 (S710: YES), a shutoff instruction signal is transmitted to the charge apparatus 30 so as to shut off the charge (S730), and the charge mid-course process is ended. Furthermore, at S730, in addition to the processing of transmitting the shutoff instruction signal to the charge apparatus 30, the processing to mechanically turn the switch 19 into the OFF state may be provided.

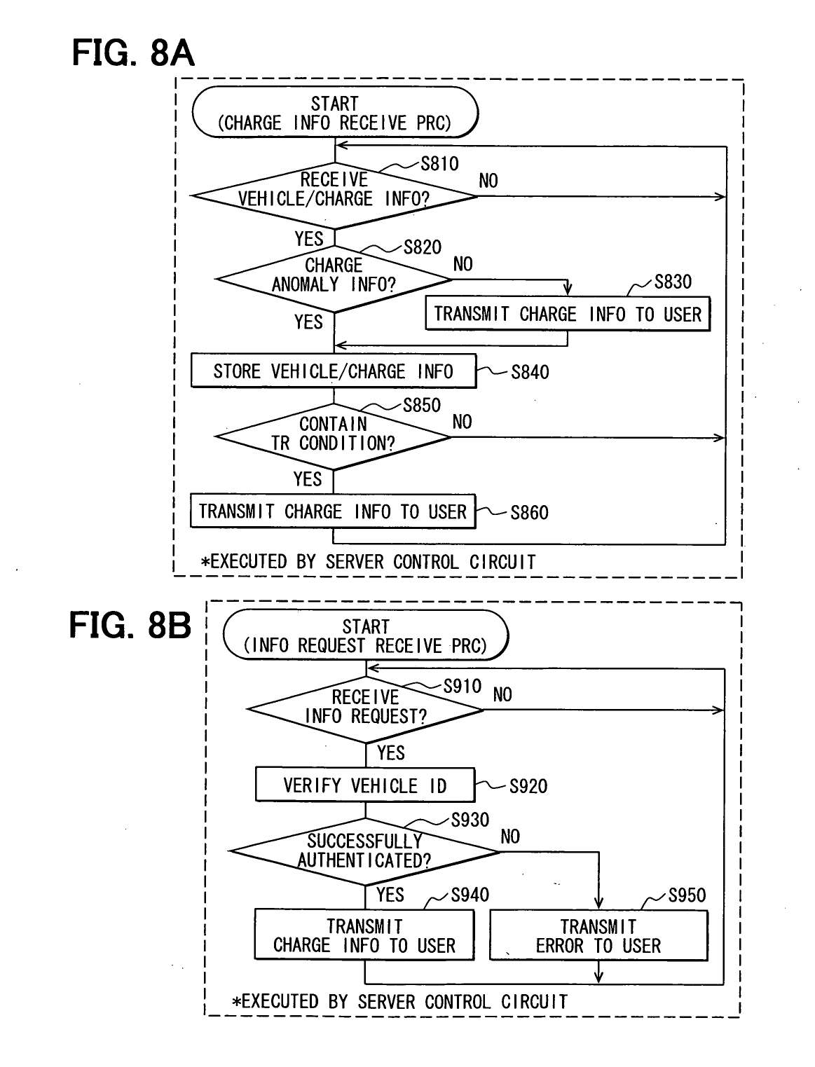

The following explains a process executed by the server 40 in response to the vehicle-side process using FIG. 8. FIG. 8A is a flowchart illustrating a charge information reception process which the server control circuit 41 of the server 40 executes. FIG. 8B is a flowchart illustrating an information request signal reception process which the server control circuit 41 of the server 40 executes.

The charge information reception process is started when the power source of the server 40 is turned into the ON state. As illustrated in FIG. 8A, first, it is determined whether charge information and vehicle information are received from the electric vehicle 10 (S810). When the charge information and vehicle information are not received from the electric vehicle 10 (S810: NO), the processing returns to S810.

In contrast, when the charge information and vehicle information are received from the electric vehicle 10 (S810: YES), it is determined whether information on charge anomaly is contained in the charge information (S820). When the information on charge anomaly (i.e., charge anomaly information) is contained in the charge information (S820: YES), an anomaly on charge is notified the terminal apparatus 60 of the user corresponding to the received vehicle information (S830). For instance, an E-mail describing a message of “the charge anomaly occurred” is transmitted to the user's terminal apparatus 60.

Then the processing advances to S840. In contrast, when it is determined that the charge information and vehicle information are not received from the electric vehicle 10 (S810: NO), the processing advances promptly to S840, where the vehicle information and charge information are stored in association with each other in the storage device 43 of the server 40 (S840).

Examples of the stored data (charge information and vehicle information) are shown in FIG. 5B. FIG. 5B includes the above-mentioned vehicle information, the charge information containing a charge amount of the battery 13 and charge remaining time, data reception date and time, a battery type, and a parking position at a charging stand (information for identifying the charge apparatus 30 being used).

The data is stored in the storage device 43 for every vehicle identified by a vehicle ID. In addition, when the data is stored in the storage device 43, the newest charge information for every vehicle may be written over the old charge information.

Then, it is determined whether the vehicle information contains the transmission condition which the user designates (S850: also referred to as a communications means or section). When the transmission condition is contained (S850: YES), the newest charge information is transmitted to the terminal apparatus 60 of the user corresponding to the vehicle information (S860: also referred to as a communications means or section), the processing at S810 and subsequent is repeated.

When the transmission condition is not contained (S850: NO), the processing at S810 and subsequent is repeated. The following explains an information request signal reception process. The information request signal reception process is started when the power source of the server 40 is turned into an ON state, and executed in parallel with the charge information reception process.

In detail, as indicated in FIG. 8B, it is determined whether a charge information request signal is received from any one of terminal apparatuses 60 (S910). When the charge information request signal is not received (S910: NO), the processing at S910 and subsequent is repeated.

In addition, when the charge information request signal is received (S910: YES), an authentication is made which collates vehicle identification information (including a password) included in the charge information request signal with the vehicle information (vehicle ID, password) stored in the storage device 43 using a function of the authentication device 44 (S920).

When the vehicle identification information accords with the vehicle information (S930: YES), it is determined that the authentication is successfully completed. Thus, the charge information is transmitted to the terminal apparatus 60 which is a source having transmitted the above charge information request signal (S940). The processing at S910 and subsequent is repeated. In contrast, when the vehicle identification information does not accord with the vehicle information (S930: NO), it is determined that the authentication is not completed. Thus, an authentication error is transmitted to the terminal apparatus 60 which is a source having transmitted the above charge information request signal (S950). The processing at S910 and subsequent is repeated.

### EFFECT

In the above mentioned charge system 1, the charge control circuit or vehicle control circuit 11 designates a communications condition used at the time of executing an outside transmission of an acquired charge state based on an instruction by a user. When the designated communications condition is turned into a satisfied state or reached, the vehicle control circuit 11 starts the communications to transmit a charge state to the server 40 which is a communications partner designated previously.

According to the charge system 1, the charge state is transmitted to a predetermined communications partner when reaching the communications condition which a user designated. Therefore, the user can detect the charge state of the vehicle without need of accessing the electric vehicle 10, even if the battery does not reach a full charge state.

In addition, in the charge system 1, the vehicle control circuit 11 specifies the charge amount of the electric vehicle based on the instruction by the user. The vehicle control circuit 11 designates the specified charge amount as a communications condition. When the acquired charge state has a value which indicates the charge amount equal to or greater than the communications condition, the vehicle control circuit 11 starts the data communications to transmit the charge state to the communications partner.

According to the charge system 1, the user can thus designate an optional charge amount without need to be limited to only the full charge amount; when the designated charge amount is reached, the designated charge amount is notified the communications partner. The communications partner can thus understand such a charge state. Therefore, if the communications partner is designated as an apparatus to allow the user to check, the user can detect the charge state when the designated charge amount is reached.

Furthermore, in the charge system 1, when the charge period, the travel distance, or the destination is inputted by the user, the vehicle control circuit 11 executes conversion of the inputted charge period, the travel distance, or the distance to the destination into a charge amount. The charge amount posterior to the conversion is designated as a charge amount of the electric vehicle.

According to the charge system 1, the user can designate a charge amount by only designating a charge period, a travel distance, or a destination, without need to directly input the charge amount. In addition, according to the charge system 1, the vehicle control circuit 11 calculates the charge period, which is necessary to charge up to the designated charge amount, and requests the user to reply whether to agree with the calculated charge period. When receiving the reply not to agree with the calculation result, the vehicle control circuit 11 requests the user to execute re-designation of the charge amount. Then, based on the instruction of the re-designation by the user, the charge amount of the electric vehicle is re-designated.

According to the charge system 1, the user can confirm the charging period at the time of executing the charge up to the designated charge amount. If the charge period is too long or too short, the charge amount can be designated again by the user.

In addition, in the charge system 1, the charge control circuit 11 displays the image showing a travel-possible range which the electric vehicle 10 can travel by the designated charge amount, in the vehicle display device 17. Thus, the user can recognize intuitively as an image a travel-possible range the vehicle can run using the charge amount designated by the user.

Furthermore, the charge system 1 includes the server 40. While the server 40 stores the communications condition and charge state received from the outside (e.g., each electric vehicle 10), the server 40 transmits the stored charge state to the terminal apparatus the relevant user holds or carries when the charge state comes to or satisfies with the communications condition. While the vehicle control circuit 11 transmits at least one time the communications condition, which the user designated, to the server 40, the vehicle control circuit 11 transmits the charge information repeatedly with predetermined time intervals since the charge to the electric vehicle 10 is started.

According to the charge system 1, the charge information is held or stored in the server 40 for every predetermined time interval. The user thus only needs to access the server 40 when intending to check the charge information during the charge. That is, without accessing the electric vehicle 10, the user can confirm the charge information; thus, the power consumption in the electric vehicle 10 can be saved.

In addition, in the charge system 1, the charge control circuit 11 shuts off an electric power supplied from an outside when the designated communications condition is satisfied or reached. In the charge system 1, the communication condition is used as a condition to shut off the electric power; thus, the charge can be stopped on the condition which the user wants.

Furthermore, in the charge system 1, the charge control circuit 11 detects an anomaly at the time of the charge to the electric vehicle. When the anomaly is detected, the electric power supplied from the outside electric power source is shut off. According to such a charge system 1, when the anomaly during the charge is detected, the charge is interrupted or shut off. An excessive load can be prevented from being applied to an outside electric power source or an electric vehicle.

In addition, in the charge system 1, in cases that the communications condition is not designated by the user, when the acquired charge state becomes or indicates the value representing the charge amount that is previously designated as being less than the full charge amount, the vehicle control circuit 11 executes data communications to transmit the charge state to the communications partner designated previously.

According to such a charge system 1, without accessing the charge system 1, the user can detect the charge state, before the charge becomes full.

### Other Embodiments

In addition, the embodiment of the present invention can be modified in various manners within a technical scope of the present invention without being limited to the above embodiment.

For example, in the above embodiment, the charge amount designation process and transmission condition designation process are executed in the electric vehicle 10; however, those processes may be executed in the server 40. In such a case, the electric vehicle 10 may only transmit charge information to the server 40 periodically.

Further, in the above embodiment, In addition, in consideration of congestion information or the travel time with respect to each nearby road, a loss of the electric power amount is calculated as a coefficient. The travel-possible distance per unit electric power amount is multiplied by the coefficient, thereby obtaining the travel-possible range for every road. Furthermore, an operating state of an electric apparatus such as an air-conditioner, a headlight, and a wiper is also taken into consideration. In contrast, a simpler configuration may be used, for instance. That is, a travel-possible distance by the electric power amount posterior to charge is calculated and used as a radius of a circle. This circle is drawn on a map while centering on the present position of the electric vehicle.

In addition, in the above embodiment, the vehicle control circuit 11 generates an image showing a travel-possible range. Alternatively, the vehicle control circuit 11 may be designed to only transmit a display instruction containing information on charge amount to an apparatus such as a navigation apparatus. In such a case, the instructed apparatus generates an image to illustrate the travel-possible range in consideration of the power consumption, e.g., in a headlight.

Furthermore, in the charge system 1, when the designated transmission condition is satisfied, the supply of the electric power by the charge apparatus 30 is shut off. In contrast, only when the battery 13 becomes the full charge state, the supply of the electric power may be shut off. In addition, even when the transmission condition is designated in the electric vehicle 10, the timing for the electric vehicle 10 to transmit the charge information to the server 40 may be fixed, whereas the timing for the server 40 to transmit the charge information to the terminal apparatus 60 may be defined to meet the designated transmission condition.

Furthermore, in the above embodiment, the vehicle input device 16 and the vehicle display device 17 are provided to be integrated into the navigation apparatus. In contrast, each device 16, 17 may be provided to be a dedicated device.

In such a case, at S340 of the charge amount designation process, an image or window relative to the travel distance may be displayed such as (c), and (d) of FIG. 4. Herein, when the user selects the “+” button or the “−” button, the displayed value can be increased or decreased. Thus, after the numerical value is selected and the “O.K.” button is selected, the charge period necessary for the electric vehicle's traveling the travel distance is displayed as shown in (e) of FIG. 4. This corresponds to S400 in FIG. 3.

Furthermore, in the above embodiment, designation of the charge period or the like is made at the time of starting the charge. Alternatively, such designation may be made after the start of the charge. Further, in the above embodiment, when the electric vehicle 10 transmits the charge information to the server 40, the charge information is transmitted using a wireless communications link. In contrast, when PLC (Power Line Communication or Power source Line Communication) can be available in between the electric vehicle 10 and the charge apparatus 30, the charge information may be transmitted using the PLC. That is, in such a case, the electric vehicle 10 transmits the charge information to the charge apparatus 30 using PLC. The charge apparatus 30 may transmit the received charge information to the server 40 via a wired communications link or wireless communications link, or via the Internet. Such a modified configuration of the above invention can provide the same advantage as that of the above embodiment.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

Aspects of the disclosure described herein are set out in the following clauses.

As a first aspect of the disclosure, a charge monitor apparatus is provided as follows. The apparatus monitors a charge state in an electric vehicle, which receives a charge by an electric power supplied from an outside electric power source, the electric vehicle traveling using an electric power due to the charge. A charge state acquisition section is configured to acquire a charge state of the electric vehicle. A communications condition designation section is configured to designate a communications condition, which is used to transmit the acquired charge state, based on an instruction by a user. A communications section is configured to execute data communications to transmit the charge state to a predetermined communications partner when the designated communications condition is satisfied.

As an optional aspect of the disclosure, the charge monitor apparatus may further comprise a charge amount designation section configured to designate a charge amount of the electric vehicle based on an instruction of the user. Herein, the communications condition designation section may be further configured to designate the designated charge amount as the communications condition; the communications section may be further configured to execute the data communications to transmit the charge state to the predetermined communications partner when the acquired charge state indicates a charge amount equal to or greater than the designated charge amount, which is designated as the communications condition.

Thus, the user can designate an optional amount of the charge without need to limit to the charge amount at the full charge state. When the designated charge amount is reached or satisfied, the communications partner can be notified of the charge state. Therefore, if the communications partner is designated as an apparatus to enable the user to check, the user can detect the charge state when the designated charge amount is reached or satisfied.

Furthermore, the “charge amount” may be any one of an electric power amount posterior to charge, a proportion of the electric power amount posterior to charge to an electric power amount at the full charge state, and an electric power amount supplied by the present charge.

As a further optional aspect of the disclosure, the above charge monitor apparatus may further comprise a conversion section. When a charge period, a travel distance, or a destination is inputted by the user, the conversion section may convert the inputted charge period, the inputted travel distance, or a distance to the inputted destination, into a charge amount posterior to conversion. Herein, the charge amount designation section may be further configured to designate the charge amount posterior to conversion as the charge amount of the electric vehicle.

Thus, the user only needs to designate a charge period, a travel distance, or a destination, without need to directly input a charge amount.

As a further optional aspect of the disclosure, the above charge monitor apparatus may further comprise a charge period calculation section configured to calculate a charge period needed to charge up to the designated charge amount; and a reply request section configured to request the user to reply whether to agree with a designation of a charge amount needing the calculated charge period; and a re-designation section configured to designate again a charge amount of the electric vehicle based on an instruction of the user when receiving the reply not to agree with the designation of the charge amount needing the calculated charge period.

Thus, a user can confirm the charge period at the time of executing the charge up to the designated charge amount. If the charge period is too long or too short, the charge amount can be designated again by the user.

For instance, a map may be previously prepared where an electric power amount of the present charge and the charge period are associated with each other. The electric power amount of the present charge signifies a difference between the target charge amount and the remaining electric power amount prior to the present charge. When the electric power amount of the charge is designated, the corresponding or associated charge period may be selected from the map. Alternatively, a calculation technique may be adopted where an electric power amount required for a charge per unit time is obtained by a temporary charge and then substituted into a predetermined arithmetic equation, thereby calculating the charge period.

Furthermore, calculating of the charge period may be executed before the start of the charge or during the charge. Furthermore, when the charge period is calculated before the start of the charge, a means may be provided to transmit an instruction signal to start the charge after completing the calculation of the charge period.

As a further optional aspect of the disclosure, the above charge monitor apparatus may further comprise a display management section configured to display in a display device an image illustrating a travel-possible range the electric vehicle is able to travel using the designated charge amount.

Thus, the user can recognize intuitively as an image a travel-possible range the vehicle can run using the charge amount designated by the user. Furthermore, the process of determining the travel-possible range may be achieved in various manners. For example, a travel-possible distance may be obtained by using a distance per unit electric power amount. The obtained travel-possible distance is used as a radius to draw a circle centering on the present position in the map displayed.

In addition, in consideration of congestion information or the travel time with respect to each nearby road, a loss of the electric power amount is calculated as a coefficient. The travel-possible distance per unit electric power amount is multiplied by the coefficient, thereby obtaining the travel-possible range for every road. Furthermore, an operating state of an electric apparatus such as an air-conditioner, a headlight, and a wiper may be considered.

In addition, the charge monitor apparatus may generate an image showing the travel-possible distance range the vehicle can run. Alternatively, the information on charge amount may be transmitted to an apparatus such as a navigation apparatus so that the navigation apparatus generates an image to illustrate a travel-possible range in consideration of the power consumption, e.g., in a headlight.

As an optional aspect to the disclosure of the above charge monitor apparatus, the communications section may be further configured to transmit, to a relaying apparatus, (i) the communications condition designated by the user at least one time, and (ii) the charge information repeatedly with predetermined time intervals since the charge to the electric vehicle is started. The relaying apparatus may store the communications condition and the charge state, both of which are received from an outside, and execute data communications to transmit the charge state to a terminal apparatus held by the user when the charge state satisfies the stored communications condition.

Thus, the charge information is stored at the communications relaying apparatus at predetermined time intervals. The user is only required to access the communications relaying apparatus when intending to check the charge information during the charge. That is, the user can check the charge information without need of accessing the charge monitor apparatus. It is thus unnecessary to cause the charge monitor apparatus to be kept in the standby state. Therefore, even if the charge monitor apparatus is mounted in an electric vehicle, the power consumption in the electric vehicle can be saved.

In the above charge monitor apparatus, the electric power supplied from an outside electric power source may be stopped when reaching a full charge state. Without need to be limited thereto, another configuration may be provided.

Thus, as an optional aspect of the disclosure, the charge monitor apparatus may further comprise a charge completion shutoff section configured to shut off the electric power supplied from the outside electric power source when the designated communications condition is satisfied.

Thus, the communications condition is used for a condition to shut off the electric power; thus, the charging can be stopped on the condition which the user wants.

As an optional aspect of the disclosure, the above charge monitor apparatus may further comprise an anomaly detection section configured to detect an anomaly at the charge to the electric vehicle; and an anomaly shutoff section configured to shut off the electric power supplied from the outside electric power source when the anomaly is detected.

Thus, the charging can be stopped when an anomaly is detected, thereby preventing an excessive load from being applied to an outside electric power source or an electric vehicle.

As a second aspect of the disclosure, a charge monitor apparatus is provided as follows. The apparatus monitors a charge state in an electric vehicle, which receives a charge by an electric power supplied from an outside electric power source, the electric vehicle traveling using an electric power due to the charge. A charge state acquisition section is configured to acquire a charge state of the electric vehicle; and a communications section is configured to execute data communications to transmit the charge state to a communications partner designated previously when the acquired charge state indicates a charge amount that is previously designated as being less than a full charge amount.

Thus, the user can detect the charge state not reaching a full charge state of the vehicle without need of accessing the charge monitor apparatus.

It will be obvious to those skilled in the art that various changes may be made in the above-described embodiments of the present invention. However, the scope of the present invention should be determined by the following claims.

What is claimed:

1. A charge monitor apparatus to monitor a charge state in an electric vehicle, which receives a charge by an electric power supplied from an outside electric power source, the electric vehicle traveling using an electric power due to the charge,
the charge monitor apparatus comprising:
a charge state acquisition section configured to acquire a charge state of the electric vehicle;
a communications condition designation section configured to designate a communications condition, which is used to transmit the acquired charge state, based on an instruction by a user; and
a communications section configured to execute data communications to transmit the charge state to a predetermined communications partner when the designated communications condition is satisfied.

2. The charge monitor apparatus according to claim 1, further comprising:
a charge amount designation section configured to designate a charge amount of the electric vehicle based on an instruction of the user,
the communications condition designation section being further configured to designate the designated charge amount as the communications condition,
the communications section being further configured to execute the data communications to transmit the charge state to the predetermined communications partner when the acquired charge state indicates a charge amount equal to or greater than the designated charge amount, which is designated as the communications condition.

3. The charge monitor apparatus according to claim 2, further comprising:
a conversion section configured,
when a charge period, a travel distance, or a destination is inputted by the user,
to convert the inputted charge period, the inputted travel distance, or a distance to the inputted destination, into a charge amount posterior to conversion,
the charge amount designation section being further configured to designate the charge amount posterior to conversion as the charge amount of the electric vehicle.

4. The charge monitor apparatus according to claim 2, further comprising:
a charge period calculation section configured to calculate a charge period needed to charge up to the designated charge amount;
a reply request section configured to request the user to reply whether to agree with a designation of a charge amount needing the calculated charge period; and
a re-designation section configured to designate again a charge amount of the electric vehicle based on an instruction of the user when receiving the reply not to agree with the designation of the charge amount needing the calculated charge period.

5. The charge monitor apparatus according to claim 2, further comprising:
a display management section configured to display in a display device an image illustrating a travel-possible range the electric vehicle is able to travel using the designated charge amount.

6. The charge monitor apparatus according to claim 1,
the communications section being further configured to transmit, to a relaying apparatus,
(i) the communications condition designated by the user at least one time, and
(ii) the charge information repeatedly with predetermined time intervals since the charge to the electric vehicle is started,
the relaying apparatus
storing the communications condition and the charge state, both of which are received from an outside,
executing data communications to transmit the charge state to a terminal apparatus held by the user when the charge state satisfies the stored communications condition.

7. The charge monitor apparatus according to claim 1, further comprising:
a charge completion shutoff section configured to shut off the electric power supplied from the outside electric power source when the designated communications condition is satisfied.

8. The charge monitor apparatus according to claim 1, further comprising:
an anomaly detection section configured to detect an anomaly at the charge to the electric vehicle; and
an anomaly shutoff section configured to shut off the electric power supplied from the outside electric power source when the anomaly is detected.

9. A charge monitor apparatus to monitor a charge state in an electric vehicle, which receives a charge by an electric power supplied from an outside electric power source, the electric vehicle traveling using an electric power due to the charge,
the charge monitor apparatus comprising:
a charge state acquisition section configured to acquire a charge state of the electric vehicle; and
a communications section configured to execute data communications to transmit the charge state to a communications partner designated previously when the acquired charge state indicates a charge amount that is previously designated as being less than a full charge amount.

10. An electric vehicle indicating a vehicle, which receives a charge by an electric power supplied from an outside electric power source and travels using an electric power due to the charge,
the electric vehicle having a function of the charge monitor apparatus according to claim 1.

11. A server comprising:
a reception section configured to receive information on charge state from an electric vehicle that indicates a vehicle, which receives a charge by an electric power supplied from an outside electric power source and travels using an electric power due to the charge; and
a transmission section configured to transmit the received information on charge state to a predetermined communications partner,
the server further having a function of the charge monitor apparatus according to claim 1.
